(19) United States
(12) Patent Application Publication
(10) Pub. No.: US 2012/0112471 A1
(43) Pub. Date: May 10, 2012

(54) ENERGY PLANT POWERED BY AIR PRESSURE

(76) Inventor: Jozo Karoglan, Lake Worth, FL (US)

(21) Appl. No.: 13/071,218

(22) Filed: Mar. 24, 2011

Related U.S. Application Data
(60) Provisional application No. 61/410,706, filed on Nov. 5, 2010.

(51) Int. Cl. H02K 7/18

(52) U.S. Cl. 290/1 R

(57) ABSTRACT

An energy plant includes a high pressure tube having one or more inputs and an output. An air intake is in fluid communication with at least a first input with one or more pumps being in fluid communication with the high pressure tube. A motor is in fluid communication with the output of the tube, the motor converting wind pressure into energy. A road bed is provided in operative communication with the plurality of pumps such that pressure applied to the road bed activates the pump to create a positive pressure within the high pressure tube.

### CROSS-REFERENCE TO RELATED APPLICATION

This application claims priority to U.S. Provisional patent Application No. 61/410,706 filed Nov. 5, 2010, in the entirety hereby incorporated by reference.

### BACKGROUND OF THE INVENTION

This invention is directed to the use of air power for driving a motor to create energy, and more particularly, the use of a network of pumps adapted to be operated by a road bed under load, so that traffic across the road bed creates the air pressure to drive the motor.

There are many conventional ways to create electric power or to drive a motor including the burning of fossil fuels to drive a turbine to turn a rotor to work with a stator to create electricity. This conventional method of producing energy has been used for over a century. However, it suffers from the shortcoming that it creates pollution including greenhouse gases, requires a vanishing resource for burning, and is subject to the whims of supply such as embargoes, price fluctuations, temporary shortages, supply line disruptions, and the like.

Alternative energy sources such as wind turbines, solar power cells, and nuclear energy have also been developed, all of which convert one type of energy into electrical energy or directly drive a motor. These energy sources have been satisfactory, however, they suffer from the respective shortcomings that they are relatively inefficient and require significant storage capacity as there is not always wind and sunshine. As a result, energy can only be generated at limited times and in limited geographical areas. Furthermore, although nuclear energy is substantially clean during use, there are substantial issues with the waste products; where to store them and how to finally dispose of them.

Accordingly, an energy source which overcomes the shortcomings of the prior art is desired.

### BRIEF SUMMARY OF THE INVENTION

An energy plant includes a high pressure tube having one or more inputs and an output. An air intake is in fluid communication with at least a first input with one or more pumps being in fluid communication with the high pressure tube. A motor is in fluid communication with the output of the tube, the motor converting wind pressure into energy. A road bed is provided in operative communication with the plurality of pumps such that pressure applied to the road bed activates the pump to create a positive pressure within the high pressure tube.

### BRIEF DESCRIPTION OF THE DRAWING

The present disclosure would be better understood by reading the written description with reference to the accompanying drawing figure, in which like reference numerals denote the similar structure and refer to like elements throughout, and which:

FIG. 1 is a schematic view of an energy plant utilizing air pressure to create energy in accordance with the invention;

FIG. 2 is an end sectional view of a railroad bed constructed in accordance with the prior art;

FIG. 3 is a top plan view of a section of a railroad bed constructed in accordance with the prior art;

FIG. 4 is an end schematic view of an energy plant utilizing a railroad bed in accordance with another embodiment of the invention;

FIG. 5 is a side schematic view of a pump constructed in accordance with another embodiment of the invention;

FIG. 6 is a schematic side sectional view of a pump constructed in accordance with yet another embodiment of the invention;

FIG. 7 is a schematic view of a rail car constructed in accordance with the invention;

FIG. 8 is a graph of the force applied by the wheels of a rail car at a given point along the track as a function of time in accordance with the invention; and

FIG. 9 is a diagram of the force applied by a wheel as a function of travel distance from a start point in accordance with the invention.

### DETAILED DESCRIPTION OF THE PREFERRED EMBODIMENTS

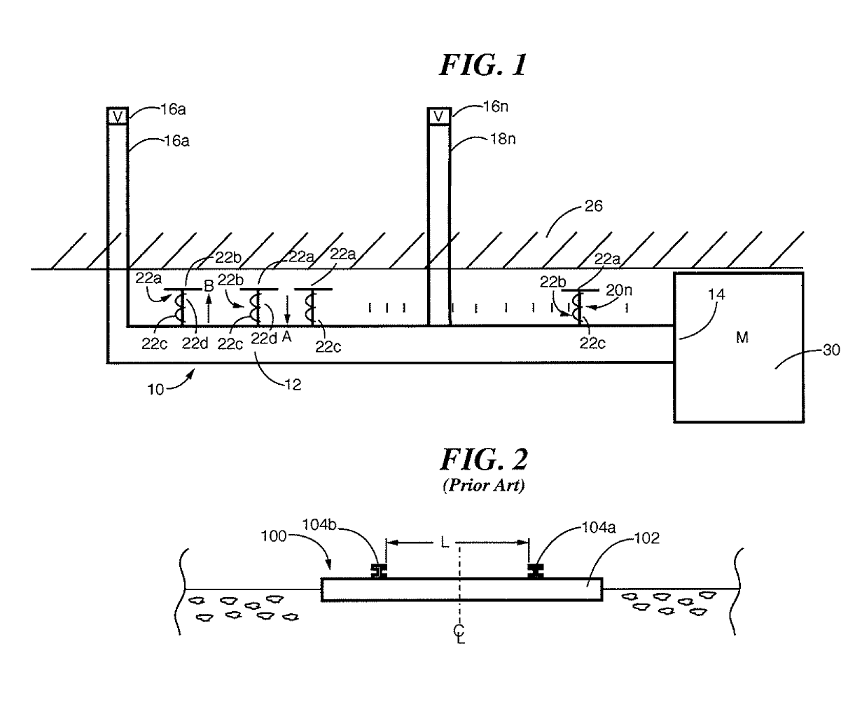

Reference is made to FIG. 1 in which an energy plant, generally indicated as 10, includes a high pressure tube 12 capable of conveying a fluid, such as a gas under pressure, along its length. Tube 12 has an output 14 and one or more air intakes 18a-18n. Air intakes 18 are in fluid communication with tube 12 and provide a pathway for ambient air to flow to tube 12 as will be discussed below. Each of air intakes 16a-16n are provided with a respective one-way valve 16a-16n which allow for air to be drawn into air intakes of 18a-18n, but prevent substantial escape of air from air intakes 18a-18n back into the ambient environment.

For ease of description, only a single output 14 is shown. However, it is well within the scope of the invention to have multiple outputs 14. Furthermore, in the preferred embodiment, to maintain pressure within tube 12, there are more intakes 16 than outputs 14.

A plurality of pumps 20a-20n are in operative fluid communication with tubing 12, along the path from intakes 18a-18n to output 14. In a preferred, but non-limiting embodiment, pumps 20a-20n are compression pumps which when moving in the direction of arrow B provide a negative pressure to draw air into intakes 18a-18n and tube 12. When compressed in the direction of arrow A, compression pumps 20a-20n provide a positive pressure raising the pressure within pressure tube 12 forcing any gas therein along a path of least resistance to output 14.

In a preferred non-limiting embodiment, pumps 20a-20n operate much like a bicycle pump or other air compression pumps as known in the art. Pump 20a, by way of example, includes a head 22a mounted on a moveable shaft. Movement of the shaft in the direction of arrow A, compresses air within a support tube 22b forcing the air into tubing 12. Head 22a may be biased by a spring 22c returning the head 22a in the direction of arrow B to the start position.

A motor 30 is operatively connected to output 14 and converts high pressure air to energy. By way of example, motor 30 may be a turbine coupled to a stator and rotor such that high pressure air moves the turbine turning the rotor to create electricity. This electricity may be used to directly power a facility, stored in a battery as is known in the art or both.

In this preferred embodiment, energy plant 10 is buried beneath a road bed 26, such that pumps 20a-20n are adapted to cooperate with a road bed 26, such that a sufficient weight applied to the road bed, such as passing vehicular traffic, moves pumps 20a-20n in the direction of arrow A forcing air into tube 12 to create a positive pressure. Furthermore, when there is less than sufficient weight on road bed 26, such as the absence of vehicular traffic, pumps 20a-20n move in the direction of arrow B to return to their original position creating a negative pressure to draw air into intake 18. In this way, as a vehicle passes across road bed 26, pumps 20a-20n are compressed and released, pushing air through tubing 12 and drawing air through air intakes 18a-18n with each passing vehicle.

In a preferred embodiment, road bed 26 is a highly trafficked road such as a highway or city street. However, it should be noted that road bed 26 could be a driveway, particularly, a well trafficked driveway or parking lot at a commercial facility, such as a factory, warehouse or shopping mall.

It is also within the scope of the invention to create a sufficient pressure at output 14 to operate hydraulic and pneumatic devices such as lifts, tools or the like.

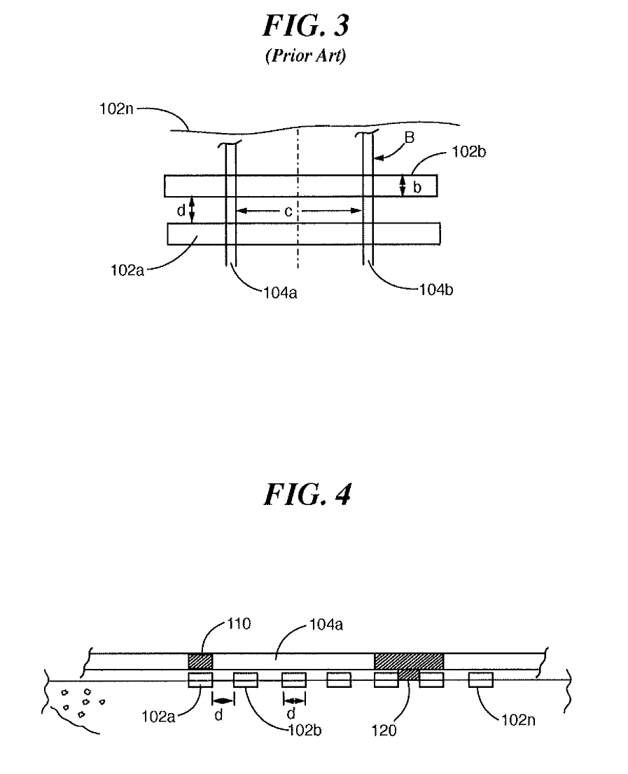

In another preferred, but nonlimiting embodiment, the energy plant can be provided in conjunction with a railroad bed to create energy from railroad traffic. Reference is made to FIGS. 2-9 which illustrate the structure and operation of the railroad bed embodiment. As shown in FIGS. 2 and 3, a conventional railroad bed, generally indicated as 100 is utilized in connection with the invention. Railroad beds 100 are uniformly sized and constructed as a function of gauge so that trains can seamlessly travel from one rail line to another. Although gauges may change from country to country, they are usually uniform within a country or region, and are made up of spaced railroad ties 102a-102n; spaced from each other across a gap d. Rails 104a, 104b lie above, and are secured to, railroad ties 102a-102n across a gap c. In the United States, by way of example, respective pairs of ties 102a, 102b; 102b-102n are separated by a gap of about 10 inches. With gap b of each respective tie is about 10 inches. Respective rails 104a, 104b are separated across gap c by distance of about 55 inches.

As shown in FIG. 5, an air pump may be disposed between, and anchored by, rails 104a, 104b in accordance with the invention. A pump may be disposed within the free space between the top of rails 102a, 102b and the top of the cross ties 102a, 102b. This provides a cross sectional area of approximately 8 inches in height by 10 inches in width if the form factor for the pump is that of pump 110 as shown in FIG. 4.

However, there is often space within the gap between adjacent rail ties 102a, 102b-102n providing an additional 10 inches of clearance. Increasing at least a portion of the pump increases the overall cross sectional area by 300% or more; resulting in a proportional change in the overall volume of the air processed by a respective pump. By utilizing a form factor which is adapted to fit within the area bounded by ties 102 and rails 104, the prior art rail structure anchors each pump in place.

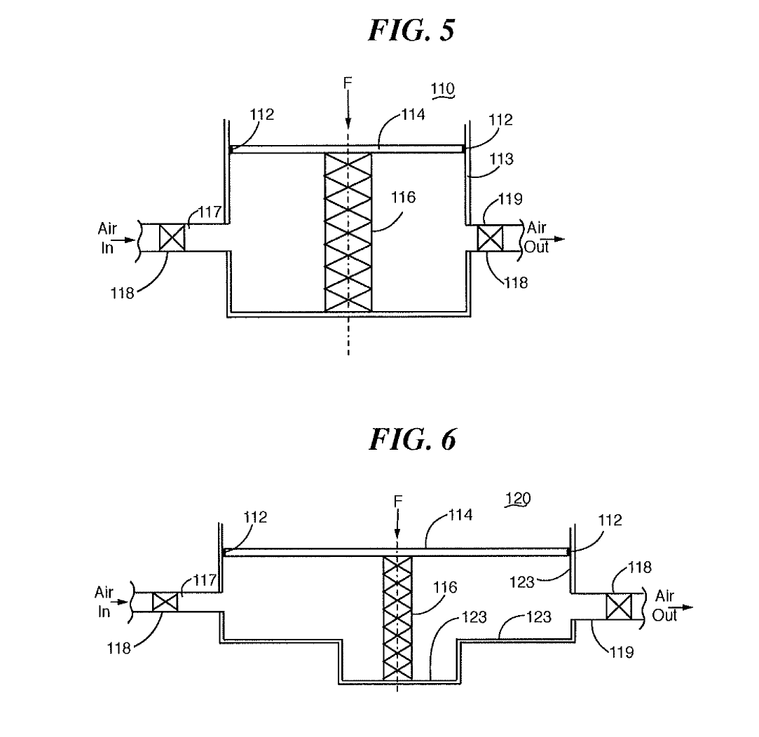

Reference is now made to FIGS. 5 and 6 wherein a pump dimensioned to take advantage of this additional area is provided. The primary difference between the embodiment of the invention in FIGS. 5 and 6 is the form factor between pump 110 and pump 120. The air pump consists of a compression chamber 113 with a plunger 114 slidably disposed within compression chamber 113. A seal 112 is disposed between plunger 114 and compression chamber 113 to maintain a substantially air tight arrangement within pump 110. A compression spring 116 is disposed between a floor of compression chamber 113 and plunger 114 to bias plunger 114 out of chamber 113 returning plunger 114 to a neutral position once compressed air is released.

Chamber 113 is provided with an inlet 117 and an outlet 119. Each of inlet 117 and outlet 119 is provided with check valves 118. During operation, a force is applied in the direction of arrow F to plunger 114 compressing spring 116 forcing air out through outlet 118. Once the force is released, spring 116 bias pushes plunger 114 to its start position creating a negative pressure within chamber 113 drawing air through inlet 117.

As seen in FIG. 6, pump 120 is similar in construction to pump 110. It also has a compression chamber 123, a plunger 124 slidably disposed therein, a spring 116, an inlet port 117 and outlet port 119, each having a one way valve 118 disposed therein and a seal 112. The primary difference between pump 110 and pump 120 being the shape of the compression chamber 123 to take advantage of the space between ties 102.

Using the dimensions above, the pump volume would be approximately 10,608 cubic inches containing a mass of air at atmospheric conditions (14.7 psi and 70° F.) of 5.52 lbm. Assuming a maximum stroke length of 6 inches, yields a final minimum volume of 2,832 cubic inches producing a maximum pressure in the compression chamber of 662 psi. To accomplish this requires a force upon plunger 114 of about 253,440 lbf in a preferred, but nonlimiting embodiment.

This force could be achieved as each set of rail car wheels cross plunger 114.

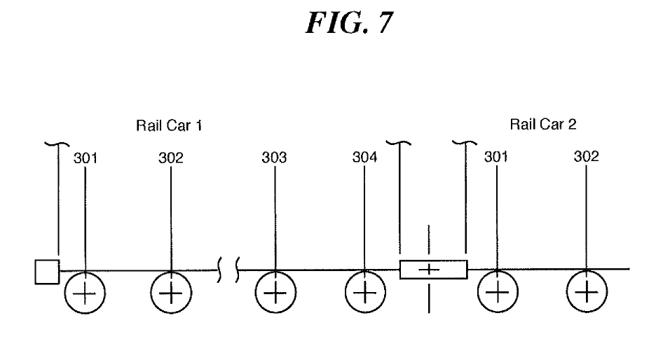

Reference is now made to FIG. 7 wherein the schematic diagram of a rail car constructed in accordance with the invention is provided. Rail cars as known in the art, have four wheel sets (not shown), two sets of wheels near the front in the traveling direction of the car and two sets of wheels near the back; the trailing edge of the car. As seen from FIG. 7, rail car 201 in accordance with the invention has supplemental wheels 301, 302 relatively close to the one end of rail car 201 and supplemental wheel sets 303 and 304 near an opposed trailing end of rail car 201. Similarly, rail car 202 has wheel sets 301, 302 and 303, 304 (not shown). Like numbers are utilized to indicate like structures. In one exemplary, but nonlimiting embodiment, 70 inches separates wheels 301 from 302 and wheels 303 from 304 and the distance from supplemental wheel 301 to supplemental wheel 304 is about 52 feet.

In one exemplary, nonlimiting embodiment, supplemental wheels 301, 302 are suspended below rail car 201 so as to apply a force F to plunges 114 as they pass over and engage pumps 110, 120. Supplemental wheels can be adjustable in height to control the amount of force F, or retractable so as not to engage pumps 110, 120 at all.

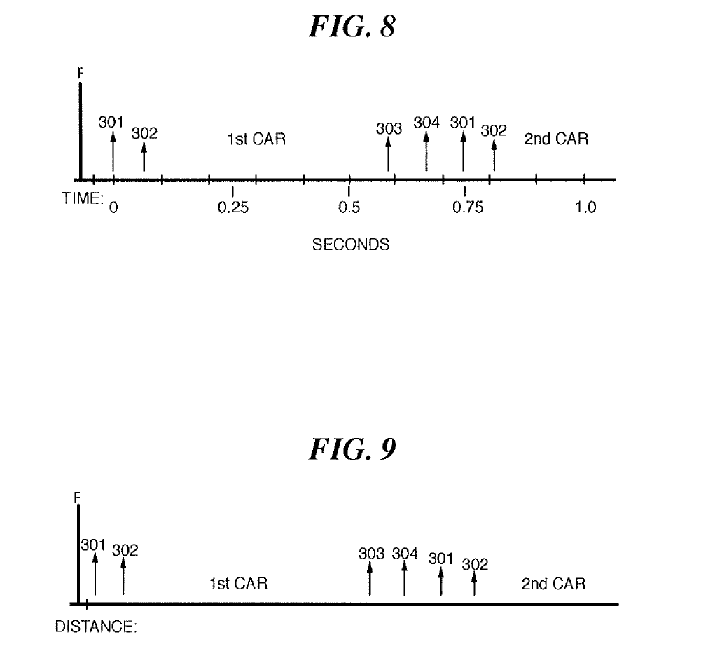

As can be seen in FIGS. 8 and 9, beginning at a time 0 and a distance 0, if in one embodiment, the train is traveling at a speed of 60 miles per hour, then force applied by supplemental wheels 301 and 302, by way of example, occur at a spaced time interval of 0.066 seconds where supplemental wheels 301, 302 are spaced apart by 70 inches. This is the equivalent of 900 cycles per minute for the plunger 134. So that with each second, there are 6 applications of force by a rail car in order to power the motors with air pressure as discussed above.

By providing a power source as a function of air and vehicular traffic, a sustainable power source which in of itself does not pollute the environment is provided. Furthermore, vehicular traffic, particularly on major highways and freeways occurs 24 hours a day, 365 days a year, rain or shine, wind or calm. It is a more reliable energy source than other “green energy sources” and does not increase the carbon footprint already present from vehicular traffic.

Thus, while there have been shown, described and pointed out novel features of the present invention as applied to preferred embodiments thereof, it will be understood that various submissions and substitutions and changes in the form and detail are contemplated to the disclosed invention which may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention which, as a matter of language, might be said to fall therebetween.

What is claimed as new and desired to be protected by Letters Patent of the United States is:

1. A power plant comprising:
a tube having at least one air intake and at least one outlet for conveying a gas therethrough;
a plurality of pumps in communication with the tube, the plurality of pumps introducing a positive pressure into the tube upon compression of at least one of the plurality of pumps and a negative pressure within the tube upon decompression of at least one of the plurality of pumps, compression of the pumps being in response to a load applied to one or more of the plurality of pumps; and
a motor in fluid communication with the outlet for converting a positive air pressure received at the outlet into electricity.

2. The power plant of claim 1, further comprising a road bed, the road bed compressing the at least one of the plurality of pumps in response to vehicular traffic thereon.

3. The power plant of claim 1, further comprising a railroad track, the railroad track having a plurality of spaced railroad ties, at least two rails, the rails being disposed along the plurality of railroad ties, the rails being spaced apart across a gap, each railroad tie being spaced from an adjacent railroad tie across a second gap, the pump being disposed within the first gap.

4. The power plant of claim 1, wherein the pump is disposed within the second gap.

5. The power plant of claim 1, wherein at least one of the plurality of pumps include a compression chamber, the compression chamber having an input in fluid communication with the air intake and an output being in fluid communication with the outlet. A plunger slidably disposed within the compression chamber and a compression spring for biasing the plunger to a start position in the absence of a compression force upon the plunger.

6. The power plant of claim 1, further comprising a pressurized gas holding tank, disposed between the plurality of pumps and the motor for holding a gas therein until a predetermined pressure of gas within the holding tank is present.

7. The power plant of claim 3, further comprising a rail car, supplemental wheels disposed below the rail car to activate the plurality of pumps as the rail car travels along the railroad track.

8. A power plant comprising:
a tube having at least one air intake and at least one outlet for conveying a gas therethrough;
a plurality of pumps in communication with the tube, the plurality of pumps introducing a positive pressure into the tube upon compression of at least one of the plurality of pumps and a negative pressure within the tube upon decompression of at least one of the plurality of pumps, compression of the pumps being in response to a load applied to one or more of the plurality of pumps;
a motor in fluid communication with the outlet for converting a positive air pressure received at the outlet into electricity;
a railroad track, the railroad track having a plurality of spaced railroad ties, at least two rails, the rails being disposed along the plurality of railroad ties, the rails being spaced apart across a gap, each railroad tie being spaced from an adjacent railroad tie across a second gap, the pump being disposed within the first gap; and
a rail car, supplemental wheels disposed below the rail car to activate the plurality of pumps as the rail car travels along the railroad track.

9. The power plant of claim 8, further comprising a pressurized gas holding tank, operatively coupled between the plurality of pumps and the motor, for holding a gas therein until a predetermined pressure of gas within the holding tank is present.

10. The power plant of claim 8, wherein at least one of the plurality of pumps include a compression chamber, the compression chamber having an input in fluid communication with the air intake and an output being in fluid communication with the outlet. A plunger slidably disposed within the compression chamber and a compression spring for biasing the plunger to a start position in the absence of a compression force upon the plunger.
